(19) United States
(12) Patent Application Publication
(10) Pub. No.: US 2008/0283517 A1
(43) Pub. Date: Nov. 20, 2008

(54) MAGNETIC FIELD-BLOCKING PANEL HEATER

(76) Inventor: Myoung Jun Lee, La Habra, CA (US)

Correspondence Address: LEE, HONG, DEGERMAN, KANG & SCHMADEKA, 660 S. FIGUEROA STREET, Suite 2300, LOS ANGELES, CA, 90017, US

(21) Appl. No.: 11/750,227

(22) Filed: May 17, 2007

(51) Int. Cl. H05B 3/10

(52) U.S. Cl. 219/548

(57) ABSTRACT

The present invention relates to a magnetic field-blocking panel heater. The magnetic field-blocking panel heater includes a panel heating element comprising a heat generating electrical conductor enclosed in an electrical insulator and first electrodes for transferring current to the electrical conductor. A magnetic field-blocking material surrounds the panel heating element. Second electrodes are respectively connected to the first electrodes of the panel heating element and extended outside of the magnetic field-blocking material for transferring current to the first electrodes, wherein the magnetic field-blocking material absorbs a magnetic field generated by the panel heating element when current is applied to the electrical conductor via the first and second electrodes.

### FIELD OF THE INVENTION

The present invention relates to a magnetic field-blocking panel heater.

### BACKGROUND OF THE INVENTION

A panel heater generally comprises a substrate, a conductive layer formed on the substrate, and electrodes formed at respective opposite ends of the conductive layer. If 12V and 2 A of electric power is applied across the two electrodes of the panel heater comprising a conductive layer having resistance of 7Ω, the temperature of the conductive layer rises by 15° C. per minute.

The panel heater is installed to be attached to a surface of an object to be heated. The object is heated by driving the heater. For example, a defroster of a refrigerator has a panel heater attached to an inner surface of the refrigerator. Hence, the defroster defrosts the inner surface of the refrigerator by generating heat from the panel heater. However, when current is applied to the conductive layer of the panel heater, a magnetic field is induced around the heater. For example, when a driving current of 12V and 30-50 W is applied to a heating sheet for an automobile, a magnetic field of 50-60 mG is detected.

Recently, a panel heater has come to be used as a heating element for heating devices used in direct contact with a human body, such as an electric sleeping mat, an automobile sheet and heated clothing, for example. Consequently, a user of such heating devices is harmed because of the close proximity of the magnetic field generated from the panel heater to the user's body. Accordingly, what is needed is a panel heater with a reduced or eliminated magnetic field, such that the user utilizing a heating device including such panel heater is not harmed when the user uses the heating device in close proximity to the user's body.

### SUMMARY OF THE INVENTION

The present invention is directed to a magnetic field-blocking panel heater.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a magnetic field-blocking panel heater comprising a panel heating element comprising a heat generating electrical conductor enclosed in an electrical insulator and first electrodes for transferring current to the electrical conductor, a magnetic field-blocking material surrounding the panel heating element, and second electrodes respectively connected to the first electrodes of the panel heating element and extending outside of the magnetic field-blocking material for transferring current to the first electrodes, wherein the magnetic field-blocking material absorbs a magnetic field generated by the panel heating element when current is applied to the electrical conductor via the first and second electrodes.

In one aspect of the invention, the magnetic field-blocking material comprises metal plates attached to upper and lower surfaces of the panel heating element. Preferably, the metal plates are attached to the upper and lower surfaces of the panel heating element by an adhesive. Preferably, the adhesive comprises at least one of a thermostatic material and a material having a heat-resistant temperature not lower than 70° C.

In another aspect of the invention, the magnetic field-blocking panel heater further comprises a magnetic field-blocking material attachment part formed when edges of the metal plates adhesively attach to one another to seal the panel heating element when the metal plates are attached to the upper and lower surfaces of the panel heating element.

Preferably, at least one of the metal plates has a thickness of 10 to 200 micrometers. Preferably, at least one of the metal plates has a thickness of 30 micrometers. Preferably, the metal plates comprise at least one of copper and aluminum.

Preferably, a current of 12V is applied to the electrical conductor. Preferably, the second electrodes comprise a lead wire.

Preferably, the metal plates comprise at least one of a rough surface and a mirror surface. Preferably, the panel heating element is capable of consuming 20 to 700 W of current.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a cross-sectional view illustrating a panel heating element used in a magnetic field-blocking panel heater in accordance with one embodiment of the present invention.

FIG. 2 is an exploded sectional view illustrating the magnetic field-blocking panel heater in accordance with one embodiment of the present invention.

FIG. 3 is a view illustrating the magnetic field-blocking panel heater in a state of performing magnetic shielding using metal plates, in accordance with one embodiment of the present invention.

FIG. 4 is a sectional view illustrating an assembled magnetic field-blocking panel heater in accordance with one embodiment of the present invention.

### DETAILED DESCRIPTION OF THE PREFERRED EMBODIMENTS

The present invention relates to magnetic field-blocking panel heater. Hereinafter, the magnetic field-blocking panel heater in accordance with preferred embodiments of the present invention will be described with reference to the accompanying drawings.

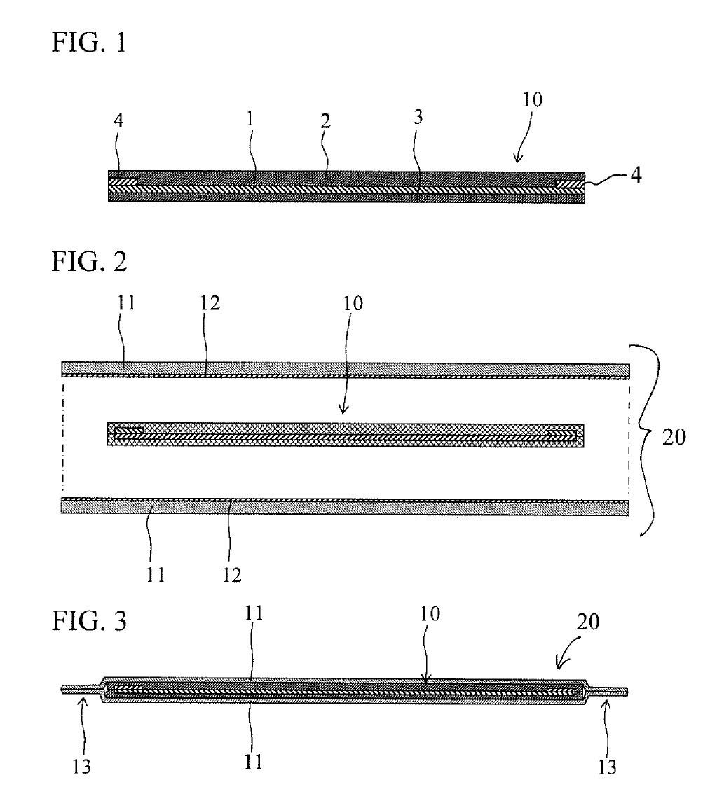

FIG. 1 illustrates a panel heating element for use in a magnetic field-blocking panel heater according to one embodiment of the present invention. FIG. 1 is an enlarged view, and thus the thickness of the panel heating element 10 shown in FIG. 1 is illustrated in an exaggerated manner. Referring to FIG. 1, the panel heating element 10 comprises an insulating base layer 3, an insulating protective layer 2, a conductive layer 1 disposed between the insulating base layer 3 and the insulating protective layer 2, and electrodes 4 installed at respective ends of the conductive layer 1. The panel heating element 10 is driven by applying direct current (DC) to the two electrodes. Preferably, a current of approximately 12 V is applied. When the driving current is applied to the two electrodes 4, the conductive layer 1, serving as a resistor, generates heat. In accordance with the present invention, the panel heating element 10 consumes 20 to 700 W of current according to the size and capacity thereof. Furthermore, the panel heating element 10 creates a magnetic field around itself when it is driven.

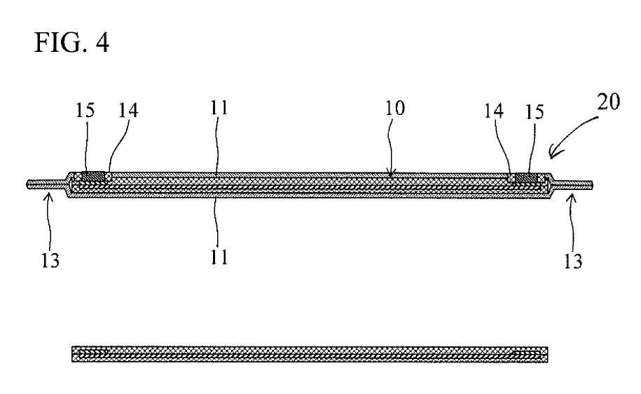

FIG. 2 is an exploded sectional view illustrating the magnetic field-blocking panel heater in accordance with one embodiment of the present invention. FIG. 3 is a view illustrating the magnetic field-blocking panel heater in a state of performing magnetic shielding using metal plates, in accordance with one embodiment of the present invention. FIG. 4 is a sectional view illustrating an assembled magnetic field-blocking panel heater in accordance with one embodiment of the present invention.

Referring to FIGS. 2-4, a magnetic field-blocking panel heater according to the present invention is provided to block a magnetic field generated when a panel heating element is driven. In accordance with one embodiment of the present invention, the magnetic field-blocking panel heater 20 comprises a panel heating element 10 in which a conductor 1 is enclosed in insulating layers 2, 3. The magnetic field-blocking heater also comprises metal plates 11 disposed on respective upper and lower surfaces of the panel heating element 10, which preferably serve as a magnetic field-blocking material.

The magnetic field-blocking panel heater 20 further comprises a magnetic field-blocking material attachment part 13 provided around the edges of the panel heating element 10 in order to seal the panel heating element 10, and external electrodes 15 connected to respective electrodes 4 of the panel heating element 10. The external electrodes 15 are insulated from the metal plates 11 by insulators 14 in order to apply a driving current to the conductor 1 of the panel heating element 10. The external electrodes 15 extend outside the metal plates (magnetic field-blocking material) 11.

In one aspect of the invention, the insulators 14 and the external electrodes 15 may be substituted by a lead wire covered by an insulator. Notably, the shape and position of the external electrodes can be different from the example shown in the drawings, and can vary diversely.

According to magnetism theory, it is known that a metal plate reflects, disturbs and absorbs a magnetic field. According to the present invention, because the panel heating element 10 is covered with the metal plates 11, the magnetic field induced around the panel heating element 10 while the panel heating element 10 is driven is reflected in a loop shape in a closed space defined by the upper and lower metal plates 11 and the magnetic field-blocking material attachment part 13. Consequently, the magnetic field becomes noise-like, is partially absorbed by the metal plates 11 and eventually vanishes. Furthermore, because the metal plates 11 are a heat conductor, heat generated from the heating element 10 can be easily transferred outside the metal plates 10.

In accordance with the present invention, opposite facing surfaces of the upper and lower metal plates 11 have adhesive layers 12, respectively. Therefore, the metal plates 11 can be easily attached onto respective upper and lower surfaces of the panel heating element 10. Preferably, the magnetic field-blocking material attachment part 13 is formed when ends of the metal plates 11 adhesively contact one another when the metal plates 11 are attached to the panel heating element 10.

In one aspect of the invention, the adhesive layers 12 may be made of a thermostatic material or a material having a heat-resistant temperature not lower than 70° C. The adhesive layers 12 can be easily applied to the surfaces of respective metal plates 11 through a roll-coating method or an adhesive spraying method. After the adhesive layers 12 are applied onto the surfaces of the metal plates 11, they can be protected by release paper. In this instance, when attaching the metal plates 11 onto the surfaces of the panel heating element 10, the release paper is removed.

In another aspect of the invention, the metal plates 11 may be copper plates or aluminum plates having a thickness of approximately 10 to 200 micrometers. Preferably, if the panel heater is used for an automobile sheet, the copper plate or the aluminum plate may have a thickness of approximately 30 micrometers.

In one aspect of the invention, if the metal plate 11 has a rough adhesive surface having the adhesive layer 12 thereon, the metal plate 11 can scatter and absorb the magnetic field more efficiently in the closed shielding space. In another aspect of the invention, if the adhesive surface of the metal plate 11 is a mirror surface, on which the adhesive layer 12 is disposed, the metal plate 11 serves as a reflective surface for reflecting the magnetic field. Notably, the mirror surface may be preferable in order to simply realize the present invention.

As described above, the present invention provides a magnetic field-blocking panel heater in which a panel heating element comprising a conductor enclosed in an insulator is covered with a magnetic field-blocking material. The magnetic field-blocking material are metal plates formed of aluminum or copper. The metal plates are attached onto respective upper and lower surfaces of the panel heating element by respective adhesive layers and a magnetic field-blocking material attachment part is provided around the edges of the panel heating element. The electrodes of the panel heating element extend outside the metal plates.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A magnetic field-blocking panel heater, comprising:
a panel heating element comprising a heat generating electrical conductor enclosed in an electrical insulator and first electrodes for transferring current to the electrical conductor;
a magnetic field-blocking material surrounding the panel heating element; and
second electrodes respectively connected to the first electrodes of the panel heating element and extending outside of the magnetic field-blocking material for transferring current to the first electrodes,
wherein the magnetic field-blocking material absorbs a magnetic field generated by the panel heating element when current is applied to the electrical conductor via the first and second electrodes.

2. The magnetic field-blocking panel heater of claim 1, wherein the magnetic field-blocking material comprises metal plates attached to upper and lower surfaces of the panel heating element.

3. The magnetic field-blocking panel heater of claim 2, wherein the metal plates are attached to the upper and lower surfaces of the panel heating element by an adhesive.

4. The magnetic field-blocking panel heater of claim 3, wherein the adhesive comprises at least one of a thermostatic material and a material having a heat-resistant temperature not lower than 70° C.

5. The magnetic field-blocking panel heater of claim 2, further comprising a magnetic field-blocking material attachment part formed when edges of the metal plates adhesively attach to one another to seal the panel heating element when the metal plates are attached to the upper and lower surfaces of the panel heating element.

6. The magnetic field-blocking panel heater of claim 2, wherein at least one of the metal plates has a thickness of 10 to 200 micrometers.

7. The magnetic field-blocking panel heater of claim 2, wherein at least one of the metal plates has a thickness of 30 micrometers.

8. The magnetic field-blocking panel heater of claim 2, wherein the metal plates comprise at least one of copper and aluminum.

9. The magnetic field-blocking panel heater of claim 1, wherein a current of 12V is applied to the electrical conductor.

10. The magnetic field-blocking panel heater of claim 1, wherein the second electrodes comprise a lead wire.

11. The magnetic field-blocking panel heater of claim 2, wherein the metal plates comprise at least one of a rough surface and a mirror surface.

12. The magnetic field-blocking panel heater of claim 1, wherein the panel heating element is capable of consuming 20 to 700 W of current.
